(19) United States
(12) Patent Application Publication
(10) Pub. No.: US 2006/0139539 A1
(43) Pub. Date: Jun. 29, 2006

(54) Multi-domain vertical alignment liquid crystal display which generates circularly polarized light

(76) Inventors: Fu-Cheng Chen, Tainan County (TW); Ming-Fong Hsieh, Tainan County (TW); Wang-Yang Li, Tainan County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/766,433

(22) Filed: Jan. 27, 2004

(30) Foreign Application Priority Data
Jan. 30, 2003 (TW) 092102322

(51) Int. Cl. G02F 1/1337

(52) U.S. Cl. 349/129

(57) ABSTRACT

A MVA LCD (Multi-domain Vertical Alignment Liquid Crystal Display) is provided. The MVA LCD includes a first substrate and a second substrate; a common electrode disposed on a first surface of the first substrate; a pixel electrode disposed on a first surface of the second substrate and corresponds to the common electrode; a plurality of liquid crystal molecules filled between the first substrate and the second substrate; a domain regulating means disposed on the first substrate or the second substrate for regulating the LC director of the liquid crystal molecules; a first quarter-wave (¼λ) plate disposed on the top of a second surface of the first substrate; a first linear light polarizer sheet disposed on the top of the first quarter-wave plate; a second quarter-wave plate disposed on the bottom of a second surface of the second substrate; and a second linear light polarizer sheet disposed on the bottom of the second quarter-wave plate. The incident light is in the form of circularly polarized light when transmitted through the liquid crystal molecules of the MVA LCD.

This application claims the benefit of Taiwan application Serial No. 92102322, filed Jan. 30, 2003.

### BACKGROUND OF THE INVENTION

1. Field of the Invention

The invention relates in general to a liquid crystal display, and more particularly to a multi-domain vertical alignment liquid crystal display (MVA LCD), which generates circularly polarized light.

2. Description of the Related Art

Due to the wide viewing angles αchievable with multi-domain vertical alignment (MVA) LCDs, they have been paid much attention recently. FIG. 1 is a lateral view of the conventional MVA LCD structure is shown. The common electrode 102 is disposed on the lower surface of the upper substrate 104. The thin-film transistor (TFT) 112 for controlling the pixel electrode 110 and the capacitor electrode 116 of the storage capacitor 114 are both disposed on the upper surface of the lower substrate 108. The gate electrode 118 of the TFT 112 is covered by the protecting layer 120 and the source electrode 122, the drain electrode 124 of the TFT 112, and the channel layer 126 are all covered by the protecting layer 125. The pixel electrode 110 is electrically coupled to the drain electrode 124 of the TFT 112 via the hole 128 on the protecting layer 125. The liquid crystal molecules 128 are interposed between the upper substrate 104 and the lower substrate 108.

In addition, a plurality of protrusions 106 are disposed on the first surface of the upper substrate 104 and that of the lower substrate 108. The upper linear polarizer sheet 130 is disposed on the top of the other surface of the upper substrate 104 and the lower linear polarizer sheet 132 is disposed on the bottom of the other surface of the lower substrate 108. The light transmission axis of the upper linear polarizer sheet 130 and the lower linear polarizer sheet 132 are perpendicular to each other.

FIG. 2A and FIG. 2B are the lateral view and the top view of the arrangement of the liquid crystal molecules are shown when the LCD is in the dark state(voltage off). When no voltage is applied between the common electrode 102 and the pixel electrode 110, most liquid crystal molecules 128A are arranged vertically to the substrate and the liquid crystal molecules 128A near the protrusion 106 are aligned vertical to the protrusion 106. When incident light is transmitted through the lower linear polarizer sheet 132, the polarization direction of the incident light is parallel to the light transmission axis of the upper linear polarizer sheet 130 and is vertical to the light transmission axis of the lower linear polarizer sheet 132 and the display appears dark.

FIG. 3A shows the lateral view of the arrangement of the liquid crystal molecules when the LCD is in the bright state (voltage on). FIG. 3B shows the top view of the ideal arrangement of the liquid crystal molecules when the LCD is in the bright state, and FIG. 3C shows the top view of the actual arrangement of the liquid crystal molecules when the LCD is in the bright state. When a specific voltage is applied between the common electrode 102 and the pixel electrode 110, most liquid crystal molecules 128B align approximately parallel to the substrate. As shown in FIG. 3B, when the included angle between the liquid crystal directors, which is aligned in the same direction as the long axis of the liquid crystal molecules, and the light transmission axis of the linear polarizer sheet 202 or 204 is 45°, there is a maximal light transmission rate Tmax. However, the included angle between the liquid crystal director of all liquid crystal molecules and the light transmission axis of the linear polarizer sheet are not all 45°, as shown in FIG. 3C. In fact, the included angle (p between the liquid crystal director of liquid crystal molecules and the light transmission axis of the linear polarizer sheet 204 may be from 0° to 90°. When the included angle φ is not 45°, the light transmission rate is decreased.

FIG. 4 shows the relationship between the included angle φ between the liquid crystal director of the liquid crystal molecules and the light transmission axis of the polarizer and the light transmission rate T is shown. When the included angle φ is near 0° or 90°, the light transmission rate T will be near minimum Tmin. In this manner, when the liquid crystal display is in the bright state, the liquid crystal molecules in which the included angle (p are not 45° will not be able to maximize the light transmission rate of the incident light. Thus, the efficiency of light utilization of the conventional LCD cannot be maximized.

In addition, the conventional LCD has suffered from narrow viewing angles. FIG. 5A shows the relationship of the view direction φ, the viewing angle Ψ, and the panel and FIG. 5B shows the contrast contour line of the conventional MVA LCD shown in FIG. 1. The projection of the viewing point P on the panel 502 is the projection point P′. The viewing direction φ is defined to be the included angle between the projection point P′ and the light transmission axis 204 of the polarizer. The angle Ψ is defined as the included angle between the viewing point P and the normal vector 506 of the panel 502. The view angle is defined to be the viewing angle Ψ when the contrast value is 10. For every viewing direction φ, the corresponding view angle is different. When the viewing direction φ is 45°, 135°, 225°, and 315°, the light leakage phenomenon will occur when the LCD is in the dark state. In this manner, the contrast value is small resulting in a decrease in brightness and less vivid colors. Therefore, when the viewing direction is 45°, 135°, 225°, and 315°, the view angle is at a minimum. In addition, since the amounts of light leakage of light of different wavelengths differ, the phenomenon of color shifting will occur.

How to improve the low efficiency of light utilization of the conventional LCD and the problems of narrow view angle and color shifting when the viewing direction is 45°, 135°, 225°, and 315° and thus improve the efficiency and display quality of the LCD are the main issues of the present invention.

### SUMMARY OF THE INVENTION

It is therefore an object of the invention to provide an improved MVA LCD which generates circularly polarized light and has the advantages of high efficiency of light utilization, wide viewing angle, and improved color shift.

The invention achieves the above-identified objects by providing a new MVA LCD (Multi-domain Vertical Alignment Liquid Crystal Display), comprising: a first substrate and a second substrate; a common electrode disposed on a first surface of the first substrate; a pixel electrode disposed on a first surface of the second substrate and corresponding to the common electrode; a plurality of liquid crystal molecules filled between the first substrate and the second substrate; a domain regulating means disposed on the first substrate or the second substrate for regulating the LC director of the liquid crystal molecules; a first quarter-wave (¼λ) plate disposed on the top of a second surface of the first substrate; a first linear light polarizer sheet disposed on the top of the first quarter-wave plate; a second quarter-wave plate disposed on the bottom of a second surface of the second substrate; and a second linear light polarizer sheet disposed on the bottom of the second quarter-wave plate. Wherein the incident light is in the form of circularly polarized light when transmitted through the liquid crystal molecules of the MVA LCD.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 shows the lateral view of the conventional MVA LCD;

FIGS. 2A and 2B show the lateral view and the top view respectively of the arrangement of the liquid crystal molecules when the LCD is in the dark state;

FIG. 3A shows the lateral view of the arrangement of the liquid crystal molecules when the LCD is in the bright state;

FIG. 3B shows the top view of the ideal arrangement of the liquid crystal molecules when the LCD is in the bright state;

FIG. 3C shows the top view of the actual arrangement of the liquid crystal molecules when the LCD is in the bright state;

FIG. 4 shows the relationship between the included angle (p between the liquid crystal director of the liquid crystal molecules and the light transmission axis of the polarizer and the light transmission rate T;

FIG. 5A shows the relationship of the view direction φ, the viewing angle Ψ, and the panel;

FIG. 5B shows the contrast contour line of the conventional MVA LCD shown in FIG. 1;

FIG. 6A shows the lateral view of the MVA LCD structure illustrated according to the preferred embodiment of the present invention;

FIG. 6B shows the relationship between the light transmission axis of the upper linear polarizer illustrated in FIG. 6A and the slow axis of the upper quarter-wave plate;

FIG. 6C shows the relationship between the light transmission axis of the lower linear polarizer illustrated in FIG. 6A and the slow axis of the lower quarter-wave plate;

FIG. 7A shows the top view of the alignment of the liquid crystal molecules of the MVA LCD illustrated in FIG. 6A when the MVA LCD is in bright state;

FIG. 7B shows the relationship between the included angle φ between the liquid crystal director of the liquid crystal molecules illustrated in FIG. 7A and the light transmission axis of the polarizer and the light transmission rate T;

FIG. 8A and FIG. 8B show that no matter what the liquid crystal director of the liquid crystal molecules is, the electric field of the circularly polarized light can be divided into the X-direction Ex and the Y-direction Ey. The included angle between the Ex/Ey and the liquid crystal director of the liquid crystal molecules are both 45° if the incident light transmits along the Z-direction;

FIG. 9 shows the relationship between the transmitting direction of the incident light and the difference of the index of refraction Δn of the liquid crystal molecules when the user looks normally (“head on”) or obliquely to the LCD respectively;

FIG. 10 shows that compensation is accomplished by the negative C-plate;

FIG. 11A˜11C show the negative C-plate inserted in the MVA LCD;

FIG. 12A shows the included angle between the light transmission axis of two linear polarizer when the user looks at the LCD normally;

FIG. 12B shows the included angle between the light transmission axis of two linear polarizer when the user looks at the LCD obliquely;

FIG. 13 shows the half-wave plate disclosed in the present invention;

FIG. 14A˜14C show the location of the half-wave plate disposed in the LCD; and

FIG. 15 shows a lateral view of the MVA LCD illustrated according to the preferred embodiment of the present invention which the quarter-wave plate, the negative C-plate, and the half-wave plate are inserted

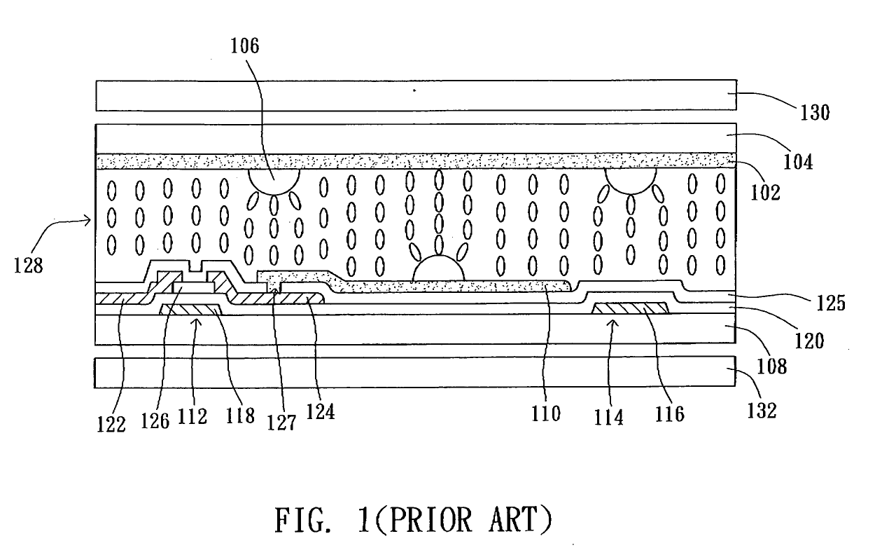

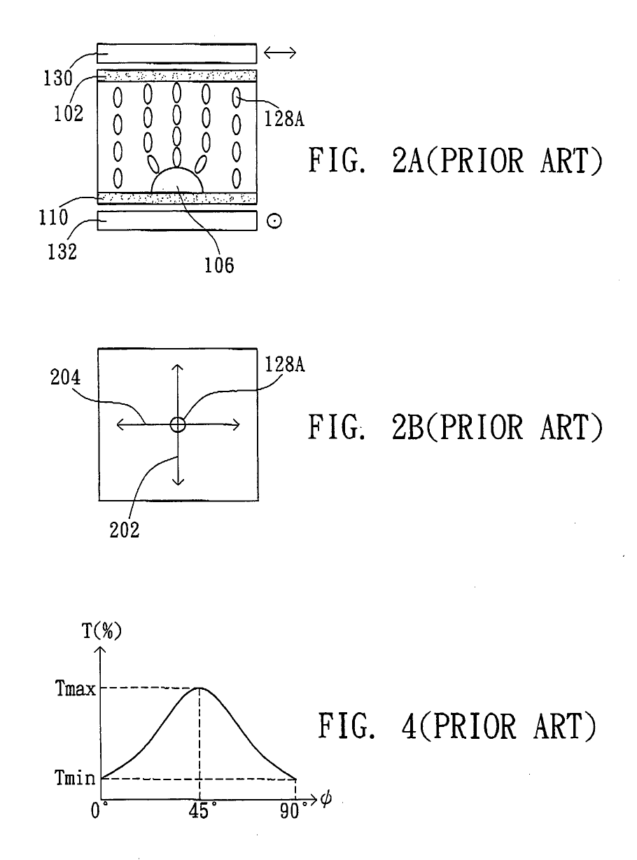

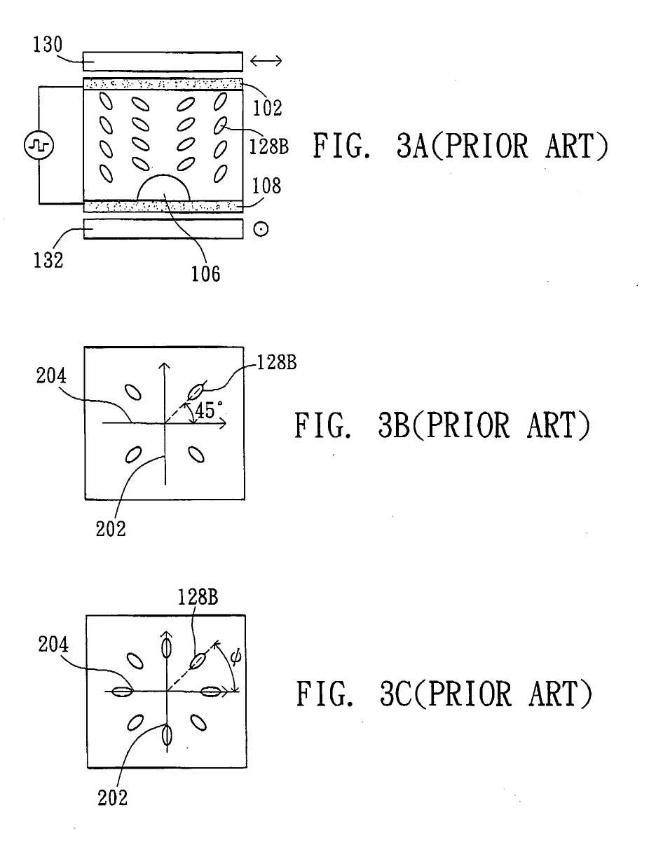

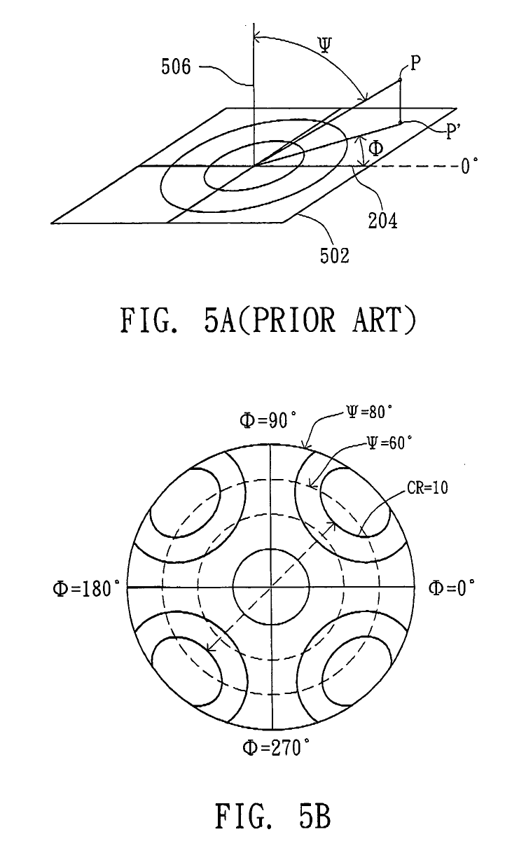

### DETAILED DESCRIPTION OF THE INVENTION

In order to improve the low efficiency of light utilization of the conventional MVA LCD structure, an MVA LCD design which generates circularly polarized light is disclosed in the present invention. By inserting two quarter-wave plates (¼λ plate) into the conventional linear polarizer sheets, the incident light is transmitted in the form of rough polarized light through the liquid crystal molecules of the MVA LCD. The efficiency of light utilization of MVA LCD can thus be increased.

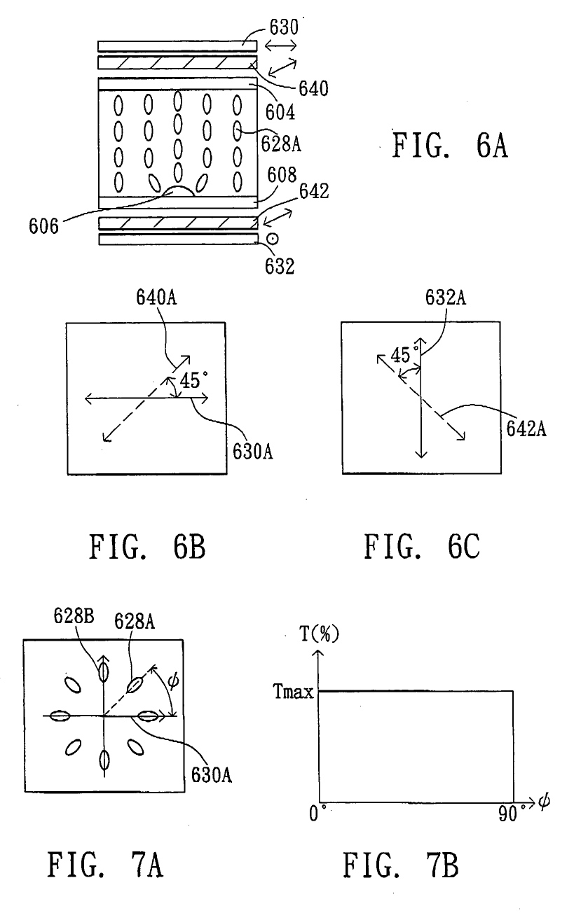

FIG. 6A shows a lateral view of the MVA LCD structure illustrated according to the preferred embodiment of the present invention. FIG. 6B shows the relationship between the light transmission axis of the upper linear polarizer illustrated in FIG. 6A and the slow axis of the upper quarter-wave plate. FIG. 6C shows the relationship between the light transmission axis of the lower linear polarizer illustrated in FIG. 6A and the slow axis of the lower quarter-wave plate. The common electrode (not shown in FIG. 6A) is formed on the first surface of the upper substrate 604. The upper quarter-wave plate 640 is disposed on the top of the second surface of the upper substrate 604 and between the upper substrate 604 and the upper linear polarizer 630. The pixel electrode (not shown in FIG. 6A) is formed on the first surface of the lower substrate 608. The lower quarter-wave plate 642 is disposed on the bottom of the second surface of the lower substrate 608 and between the lower substrate 608 and the lower linear polarizer 632.

The included angle between the slow axis 640A of the upper quarter-wave plate 640 and the light transmission axis 630A of the upper linear polarizer 630 is 45° and the included angle between the slow axis 642A of the lower quarter-wave plate 642 and the light transmission axis 632A of the lower linear polarizer 632 is 45°. The upper quarter-wave plate 640 and the upper linear polarizer 630 form a right-hand circular polarizer and the lower quarter-wave plate 642 and the lower linear polarizer 632 are form a left-hand circularly polarizer.

When no voltage is applied between the common electrode and the pixel electrode, most liquid crystal molecules are aligned in the direction vertical to the substrate. After the incident light transmits through the left-hand circular polarizer formed by the lower linear polarizer 632 and the lower quarter-wave plate 642, the incident light will become left-hand circularly polarized light. The liquid crystal molecules vertical to the substrate can be viewed as transparent and they have no influence on the incident light. When the left-hand circularly polarized light reaches the right-hand circular polarizer formed by the upper linear polarizer 630 and the upper quarter-wave plate 640, the light will not be blocked by the upper linear polarizer 630 and the upper quarter-wave plate 640. Therefore, the MVA LCD is in dark state.

When the specified voltage is applied between the common electrode and the pixel electrode, most liquid crystal molecules are aligned in the direction parallel to the substrate. When incident light transmits through the left-hand round polarizer formed by the lower linear polarizer 632 and the lower quarter-wave plate 642, the incident light will become left-hand circularly polarized light. When the left-hand circularly polarized light passes through the liquid crystal molecules, which are parallel to the substrate, the left-hand circularly polarized light will become right-hand circularly polarized light and transmit through the right-hand circular polarizer formed by the upper linear polarizer 630 and the upper quarter-wave plate 640. Consequently, the MVA LCD is in bright state.

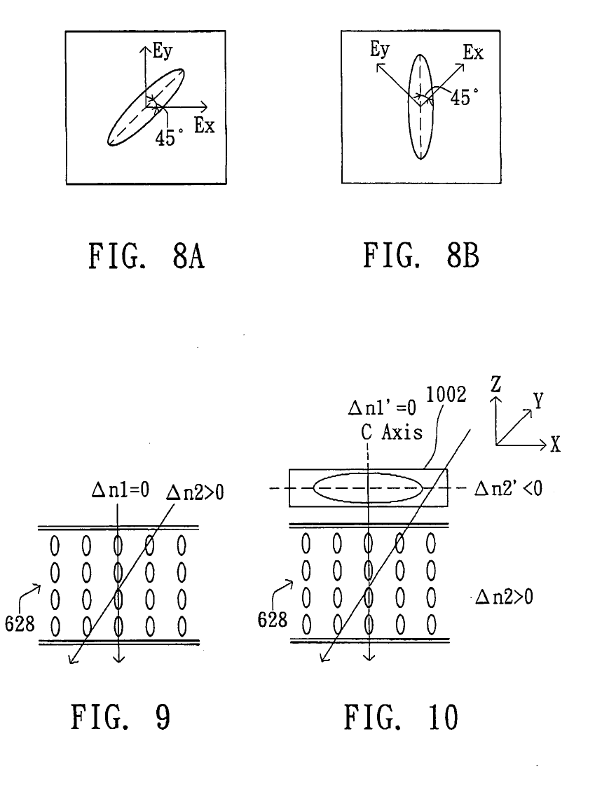

FIG. 7A shows the top view of the alignment of the liquid crystal molecules of the MVA LCD illustrated in FIG. 6A when the MVA LCD is in bright state and FIG. 7B shows the relationship between the included angle (p between the liquid crystal director of the liquid crystal molecules illustrated in FIG. 7A and the light transmission axis of the polarizer and the light transmission rate T. When incident light transmits through the left-hand circular polarizer formed by the lower linear polarizer 632 and the lower quarter-wave plate 642, the incident light will become left-hand circularly polarized light. The phase difference between the X-direction and Y-direction of the electric field of the left-hand circularly polarized light is 90°. When passing through the liquid crystal molecules which have the retardation value And, the phase difference between the X-direction and Y-direction of the electric field of the left-hand circularly polarized light becomes 270° to make the incident light become right-hand circularly polarized light. No matter what the liquid crystal director of the liquid crystal molecules is, the electric field of the circularly polarized light can be divided into the X-direction Ex and the Y-direction Ey and the included angle between Ex/Ey and the liquid crystal director of the liquid crystal molecules are both 45° (if the incident light transmits along the Z-direction), as shown in FIG. 8A and FIG. 8B. In this manner, no matter what the liquid crystal director of the liquid crystal molecules is, the retardation of the X-direction Ex and the Y-direction Ey are the same. For example, the retardation of the liquid crystal molecules 628A in which the corresponding included angle is 45° is the same with that of the liquid crystal molecules 628B in which the corresponding included angle is 90°. Therefore, no matter what the included angle φ is, the light transmission rate of the incident light is maximum Tmax. Thus, the present invention can increase efficiency of light utilization.

Also, a half-wave plate and a negative C-plate are used in the MVA LCD of the present invention to improve the narrow viewing angle and help correct the color shift problem caused by light leakage.

In general, when the LCD is in dark state, light leakage occurs mainly for the following two reasons. First, the equivalent difference in refractive index between the long and the short axes of the liquid crystal molecules when the user looks normally and looks obliquely respective to the LCD are different. Second, the included angles between the light transmission axes of the two linear polarizers when the user looks normally and looks obliquely respective to the LCD are different.

FIG. 9 shows the relationship between the transmitting direction of the incident light and the difference in the index of refraction Δn of the liquid crystal molecules when the user looks normally or obliquely respective to the LCD. When the user look normally at the LCD, the difference in the index of refraction Δn1 of the liquid crystal molecules 628 corresponding to the incident light is equal to 0. However, when the user looks obliquely at the LCD, the difference in the index of refraction Δn2′ of the liquid crystal molecules 628 corresponding to the incident light is a positive number instead of 0. In order to make Δn1 and Δn2 equal, the negative C-plate is used for compensation in the present invention. By inserting the negative C-plate, the difference between the indices of refraction Δn1 and Δn2′ is 0.

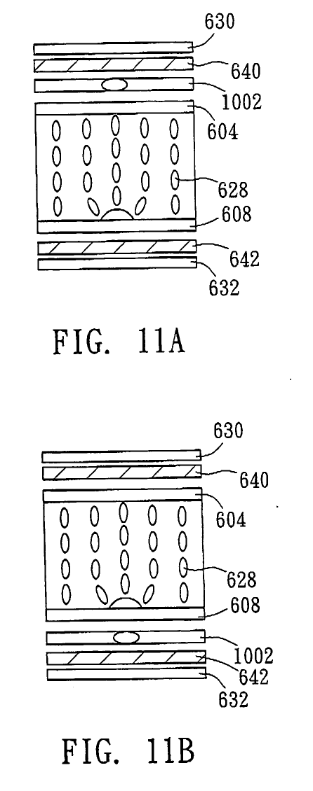

FIG. 10 shows that compensation is accomplished by the negative C-plate. The C-axis of the negative C-plate 1002 is disposed along the Z-direction. When incident light transmits along the C-axis of the negative C-plate 1002, the difference of the index of refraction Δn1′ corresponding to the incident light is 0. When the incident light transmits obliquely through the negative C-plate 1002, the difference of the index of refraction Δn2′ corresponding to the incident light is a negative number. In the present invention, the absolute value of Δn2′ is designed to be equal to the absolute value of Δn2′ of the liquid crystal molecules 628 corresponding to the oblique incident light. In this manner, when the oblique incident light transmits through the negative C-plate 1002 and the liquid crystal molecules 628, the equivalent difference of the index of refraction is the sum of the difference of the index of refraction Δn2′ of the liquid crystal molecules 628 and the difference of the index of refraction Δn2′ of the negative C-plate, that is 0. Therefore, equivalent difference of the index of refraction corresponding to the oblique incident light and that of the normal incident light are the same. Thus, the usual light leakage resulting in a low efficiency of light utilization does not occur.

FIGS. 11A˜11C show the negative C-plate disposed in the MVA LCD. As shown in FIG. 11A, the negative C-plate 1002 can be disposed on the top of the second surface of the upper substrate 604 and between the upper substrate 604 and the upper quarter-wave plate 640. As shown in FIG. 11B, the negative C-plate 1002 can also be disposed on the bottom of the second surface of the lower substrate 608 and between the lower substrate 608 and the lower quarter-wave plate 642. As shown in FIG. 11C, the negative C-plate 1002 can further be replaced by two negative C-plates 1002A and 1002B. The negative C-plate 1002A is disposed between the upper substrate 604 and the upper quarter-wave plate 640 and the negative C-plate 1002B is disposed between the lower substrate 608 and the lower quarter-wave plate 642. For oblique incident light, the sum of the difference of the indices of refraction of the negative C-plate 1002A and that of the negative C-plate 1002B is equal to Δn2′. It should be noted that the value of Δn2′ and Δn2′ correspond to the incident angle of the oblique incident light.

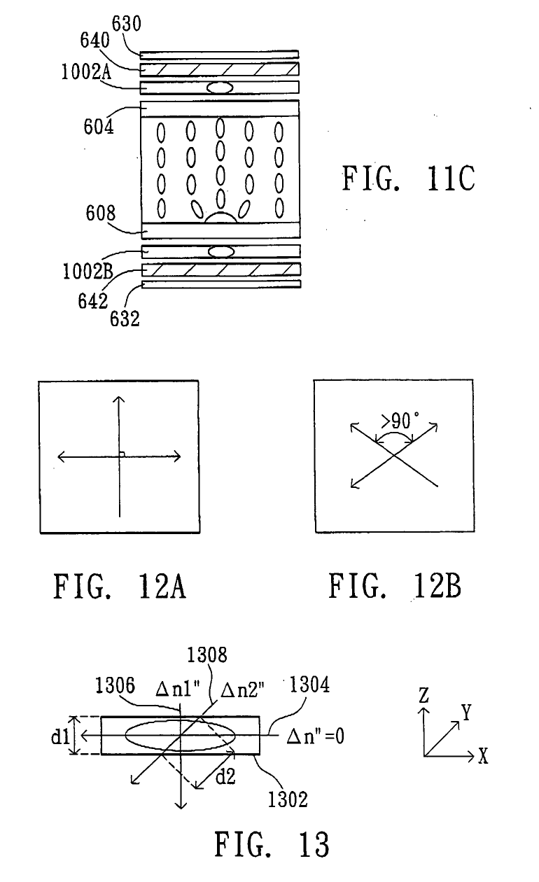

FIG. 12A shows the included angle between the light transmission axes of two linear polarizers when the user looks at the LCD normally and FIG. 12B shows the included angle between the light transmission axes of two linear polarizers when the user looks at the LCD obliquely. When the user looks at the LCD normally, the included angle between the light transmission axes of the two linear polarizers is 90°. When the LCD is in dark state, light leakage will not occur. However, when the user looks at the LCD obliquely, the included angle between the light transmission axes of the two linear polarizers is larger than 90°. In this manner, when the LCD is in dark state, light leakage will occur.

In the present invention, the half-wave plate (i.e. ½λ plate) is used to compensate for and resolve the light leakage problem. FIG. 13 shows the half-wave plate disclosed in the present invention. One of the features of the half-wave plate is that the retardation of normal incident light and oblique incident light is both 0 in the half-wave plate. When incident light 1304 normally incidents to the side of the half-wave plate 1302, the corresponding the difference of the indices of refraction Δn″ is 0. When incident light 1306 normally incidents to the top of the half-wave plate 1302, the corresponding the difference of the indices of refraction Δn1″ is a positive number. When incident light 1308 obliquely incidents to the top of the half-wave plate 1302, the corresponding the difference of the indices of refraction Δn2″ is a positive number and is smaller than Δn1″. Wherein the transmission path of the incident light 1306 transmitted through the half-wave plate 1302 is d1 and the transmission path of the incident light 1308 transmitted through the half-wave plate 1302 is d2 larger than d1. In the present invention, the half-wave plate 1302 is designed that Δn1″×d1 is equal to Δn2″×d2. That is, the retardation of the normal incident light 1306 is equal to that of the oblique incident light 1308 when transmitted to the half-wave plate 1302.

In addition, through computer simulation, when the NZ factor of the half-wave plate is larger than 0.4 and smaller than 0.6, preferably equal to 0.5, the light leakage problem when the included angle between the light transmission axes of the two linear polarizers is larger than 90° can be resolved. The NZ factor is defined to be NZ=(nx−nz)/(nx−ny), nx, ny, and nz are the indices of refraction of the half-wave plate in the λ, Y, and Z-direction respectively.

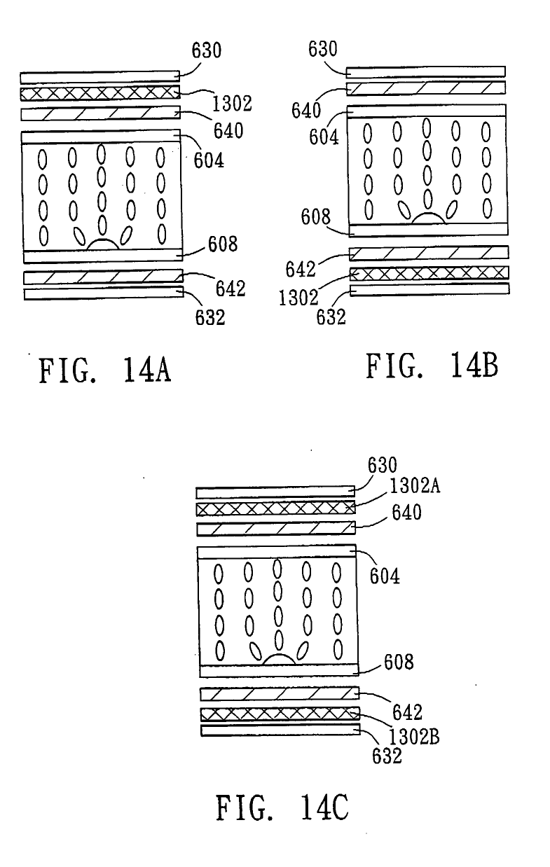

FIG. 14A˜14C show the location of the half-wave plate disposed in the LCD. The half-wave plate 1302 can be disposed between the upper linear polarizer 630 and the upper quarter-wave plate 640, as shown in FIG. 14A. The half-wave plate 1302 can be disposed between the lower linear polarizer 632 and the lower quarter-wave plate 642, as shown in FIG. 14B. The half-wave plate 1302 can be replaced by two half-wave plates 1302A and 1302B. The half-wave plate 1302A can be disposed between the upper linear polarizer 630 and the upper quarter-wave plate 640 and the half-wave plate 1302B can be disposed between the lower linear polarizer 632 and the lower quarter-wave plate 642. The sum of the NZ factors of the half-wave plates 1302A and 1302B is larger than 0.4 and smaller than 0.6, preferably equal to 0.5.

Wherein, the slow axis of the half-wave plate 1302 is parallel to the light transmission axis of the upper linear polarizer 630 or parallel to the light transmission axis of the lower linear polarizer 632.

When the light leakage problem resulting from the two reasons disclosed above is resolved, the color shift problem is also resolved.

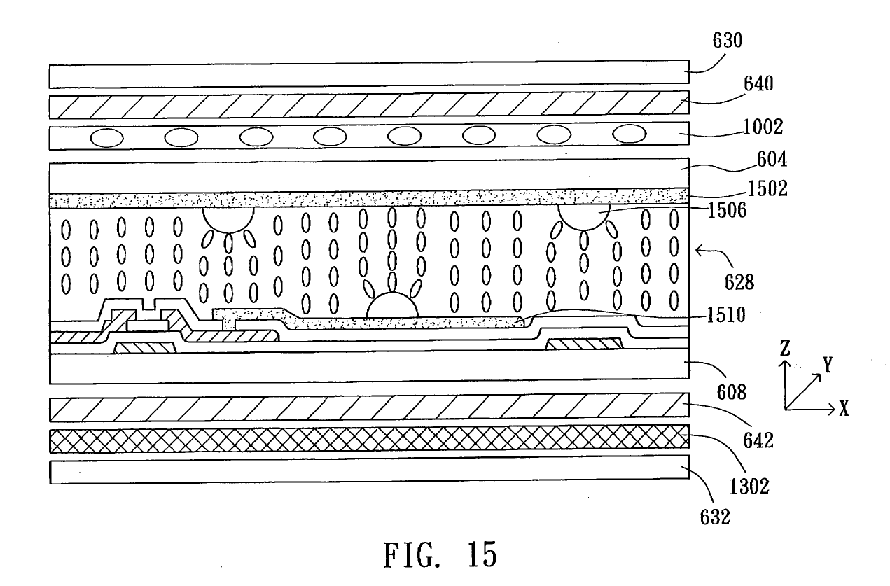

FIG. 15 shows the lateral view of the MVA LCD illustrated according to the preferred embodiment of the present invention, in which the quarter-wave plate, the negative C-plate, and the half-wave plate are inserted. The common electrode 1502 is disposed on the lower surface of the lower substrate 604. The pixel electrode 1510 is disposed on the upper surface of the upper substrate 608, and corresponds to the common electrode 1502. The liquid crystal molecules 628 are sealed between the upper substrate 604 and the lower substrate 608. A domain regulating means is disposed on the upper substrate 604 or the lower substrate 608 for regulating the liquid crystal director of the liquid crystal molecules. The domain regulating means can be a protrusion.

The upper quarter-wave plate 640 is disposed on the top of the upper surface of the upper substrate 604. The upper linear polarizer 630 is disposed on the top of the upper quarter-wave plate. The lower quarter-wave plate is disposed on the bottom of the lower surface of the lower substrate 608. The lower linear polarizer is disposed on the bottom of the lower quarter-wave plate. The half-wave plate 1302 is disposed between the lower linear polarizer 632 and the lower quarter-wave plate. The negative C-plate 1002 is disposed between the upper substrate 604 and the upper quarter-wave plate 640.

Although the half-wave plate 1302 is disposed between the lower linear polarizer 632 and the lower quarter-wave plate and the negative C-plate 1002 is disposed between the upper substrate 604 and the upper quarter-wave plate 640 according to this embodiment of the present invention shown in FIG. 15, the half-wave plate 1302 can be disposed between the upper linear polarizer 630 and the upper quarter-wave plate 640 and the negative C-plate 1002 can be disposed between the lower substrate 608 and the lower quarter-wave plate 642 as well. Besides, the half-wave plate 1302 can be equivalently replaced by two half-wave plates and the negative C-plate can be equivalently replaced by two negative C-plates. Wherein the light transmits through the liquid crystal molecules 628 of the LCD in the form of circularly polarized light.

The domain regulating means 1506 can be accomplished not only by a protrusion but also other forms such as a groove, a cone-shape bump, or the combination of a groove and a protrusion. Any domain regulating means used in a multi-domain LCD can be used in the present invention.

In addition, the NZ value of the quarter-wave plate is larger than 0.4 and smaller than 0.6, preferably equal to 0.5.

The MVA LCD of the present invention which uses circularly polarized light has the advantages of high efficiency of light utilization, broad viewing angle, and improved color shift.

While the invention has been described by way of examples and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A MVA LCD (Multi-domain Vertical Alignment Liquid Crystal Display), comprising:
a first substrate and a second substrate;
a common electrode disposed on a first surface of the first substrate;
a plurality of pixel electrodes disposed on a first surface of the second substrate and corresponding to the common electrode;
a plurality of liquid crystal molecules filled between the first substrate and the second substrate;
a domain regulating means disposed on the first substrate or the second substrate for regulating the LC director of the liquid crystal molecules;
a first quarter-wave (¼λ) plate disposed on the top of a second surface of the first substrate;
a first linear light polarizer sheet disposed on the top of the first quarter-wave plate;
a second quarter-wave plate disposed on the bottom of a second surface of the second substrate; and
a second linear light polarizer sheet disposed on the bottom of the second quarter-wave plate;
wherein the incident light is in the form of circularly polarized light when transmitted through the liquid crystal molecules of the MVA LCD.

2. The MVA LCD according to claim 1, wherein the included angle between the slow axis of the first quarter-wave plate and a first transmission axis of the first linear light polarizer sheet is substantially 45° and the included angle between the slow axis of the second quarter-wave plate and a second transmission axis of the second linear light polarizer sheet is substantially 45°.

3. The MVA LCD according to claim 1, wherein the MVA LCD further includes a half-wave (½λ) plate disposed between the first quarter-wave plate and the first linear light polarizer sheet or between the second quarter-wave plate and the second linear light polarizer sheet.

4. The MVA LCD according to claim 3, wherein the range of the NZ coefficient of the half-wave plate is between 0.4 and 0.6.

5. The MVA LCD according to claim 4, wherein the NZ coefficient of the half-wave plate is substantially equal to 0.5.

6. The MVA LCD according to claim 3, wherein the slow axis of the half-wave plate is parallel to a first light transmission axis of the first linear light polarizer sheet or a second light transmission axis of the second linear light polarizer sheet.

7. The MVA LCD according to claim 1, wherein the MVA LCD further includes a first half-wave plate disposed between the first quarter-wave plate and the first linear light polarizer sheet and a second half-wave plate disposed between the second quarter-wave plate and the second linear light polarizer sheet, wherein the range of the NZ coefficient of the first and second half-wave plates are both between 0.4 and 0.6.

8. The MVA LCD according to claim 7, wherein the sum of the NZ coefficient of the first and second half-wave plates is substantially equal to 0.5.

9. The MVA LCD according to claim 1, wherein the range of the NZ coefficient of the first and the second quarter-wave plates are both between 0.4 and 0.6.

10. The MVA LCD according to claim 9, wherein the NZ coefficient of the first and the second quarter-wave plates are both substantially equal to 0.5.

11. The MVA LCD according to claim 1, wherein the MVA LCD further includes a negative C-plate disposed between the first substrate and the first quarter-wave plate or disposed between the second substrate and the second quarter-wave plate, wherein the oblique refractive index of the negative C-plate is approximately equal to the negative value of the difference of the oblique refractive index of the liquid crystal molecules.

12. The MVA LCD according to claim 1, wherein the MVA LCD further includes a first negative C-plate disposed between the first substrate and the first quarter-wave plate and a second negative C-plate disposed between the second substrate and the second quarter-wave plate, wherein the oblique refractive index of the first and the second negative C-plates are both approximately equal to the negative value of the difference of the oblique refractive index of the liquid crystal molecules.

13. A MVA LCD, comprising:
a first substrate and a second substrate;
a common electrode disposed on a first surface of the first substrate;
a pixel electrode disposed on a first surface of the second substrate and corresponding to the common electrode;
a plurality of liquid crystal molecules filled between the first substrate and the second substrate;
a domain regulating means disposed on the first substrate or the second substrate for regulating the LC director of the liquid crystal molecules;
a first quarter-wave (¼A) plate disposed on the top of a second surface of the first substrate;
a first linear light polarizer sheet disposed on the top of the first quarter-wave plate;
a second quarter-wave plate disposed on the bottom of a second surface of the second substrate;
a second linear light polarizer sheet disposed on the bottom of the second quarter-wave plate;
a half-wave plate disposed between the first quarter-wave plate and the first linear light polarizer sheet or between the second quarter-wave plate and the second linear light polarizer sheet; and
a negative C-plate disposed between the first substrate and the first quarter-wave plate or disposed between the second substrate and the second quarter-wave plate;
wherein the incident light is in the form of circularly polarized light when transmitted through the liquid crystal molecules of the MVA LCD.

14. The MVA LCD according to claim 13, wherein the included angle between the slow axis of the first quarter-wave plate and a first transmission axis of the first linear light polarizer sheet is substantially 45° and the included angle between the slow axis of the second quarter-wave plate and a second transmission axis of the second linear light polarizer sheet is substantially 45°.

15. The MVA LCD according to claim 13, wherein the range of the NZ coefficient of the half-wave plate is between 0.4 and 0.6.

16. The MVA LCD according to claim 15, wherein the NZ coefficient of the half-wave plate is substantially equal to 0.5.

17. The MVA LCD according to claim 13, wherein the slow axis of the half-wave plate is parallel to a first light transmission axis of the first linear light polarizer sheet or a second light transmission axis of the second linear light polarizer sheet.

18. The MVA LCD according to claim 13, wherein the oblique refractive index of the negative C-plate is approximately equal to the negative value of the difference of the oblique refractive index of the liquid crystal molecules.

19. The MVA LCD according to claim 13, wherein the range of the NZ coefficient of the first and the second quarter-wave plate is between 0.4 and 0.6.

20. The MVA LCD according to claim 19, wherein the NZ coefficient of the first and the second quarter-wave plates are both substantially equal to 0.5.
